(19) United States
(12) Patent Application Publication
(10) Pub. No.: US 2008/0090693 A1
(43) Pub. Date: Apr. 17, 2008

(54) Planetary transmission having a continuously variable transmission ratio

(75) Inventors: Andreas Triller, Buhl (DE); Martin Vornehm, Wooster, OH (US)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/906,145

(22) Filed: Sep. 28, 2007

Related U.S. Application Data
(60) Provisional application No. 60/901,485, filed on Feb. 15, 2007.

(30) Foreign Application Priority Data
Sep. 28, 2006 (DE) 10 2006 045 854.0

(51) Int. Cl. F16H 15/50; F16H 3/76

(52) U.S. Cl. 475/300

(57) ABSTRACT

A planetary transmission having a continuously variable transmission ratio. Two sun wheels with sun wheel outer circumferential surfaces are rotatable coaxially at different rotational speeds and coaxially spaced from each other. A ring wheel is coaxial with the sun wheels and has a radially inner circumferential surface. Planet wheels having planet wheel outer circumferential surfaces are in frictional contact with the ring wheel inner circumferential surface and the sun wheel outer circumferential surfaces. The sun wheel outer circumferential surfaces, the planet wheel outer circumferential surfaces, and the ring wheel inner circumferential surface are so shaped that when there is axial displacement of the ring wheel relative to the sun wheels, tilting of the axes of rotation of the planet wheels relative to the axis of rotation of the sun wheels occurs. The transmission ratio between the sun wheels changes in opposite directions.

### BACKGROUND OF THE INVENTION

1. Field of the Invention

The invention relates to a planetary transmission having a continuously variable transmission ratio.

2. Description of the Related Art

Transmissions having a continuously variable transmission ratio, which are also known as variators, are normally designed as belt-driven transmissions, in which the force is transmitted through traction media such as wide V-belts, plate-link chains, or link belts, or as friction transmissions, such as toroidal transmissions or conical ring transmissions.

A characteristic of the friction transmissions is that the planet gears must be supported, tilted and clamped by means of components that are specifically provided for that purpose.

An object of the invention is to provide a planetary transmission having a continuously variable transmission ratio and of simple construction.

### SUMMARY OF THE INVENTION

The present invention provides a planetary transmission having a continuously variable transmission ratio. The transmission includes two axially spaced, opposed sun wheels having sun wheel outer circumferential surfaces which are each rotatable around the same axis of rotation at different speeds of rotation. A ring wheel is positioned on the same axis as the sun wheels and has a radially inner circumferential surface. Planet wheels are provided having planet wheel outer circumferential surfaces that are in frictional contact with the inner circumferential surface of the ring wheel and with the outer circumferential surfaces of the sun wheels. The sun wheel outer circumferential surfaces, the planet wheel outer circumferential surfaces, and the inner circumferential surface of the ring wheel are so shaped that when there is axial displacement of the ring wheel relative to the sun wheels, tilting of the axes of rotation of the planet wheels relative to the axis of rotation of the sun wheels occurs, and the transmission ratios between the ring wheel and each of the sun wheels change in opposite directions. The planetary transmission in accordance with the invention is simple in construction and low in wear and maintenance.

Because each planet wheel outer circumferential surface is in frictional contact with the two sun wheels on different sides of a center plane that extends perpendicular to the axis of rotation of the corresponding planet wheel, and is in frictional contact with the inner circumferential surface of the ring wheel in at least one position, and the planet wheel outer circumferential surfaces are so shaped that the planet wheels are held axially by the frictional contact with the sun wheels and the ring wheel, a planet carrier is not absolutely necessary.

Advantageously, one sun wheel is rigidly connected to a shaft and the other sun wheel is rotatably supported on the shaft and is biased in a direction toward the first sun wheel, which supports the contact pressure that is necessary for a friction transmission.

Advantageously, the planet wheel outer circumferential surfaces can taper toward the front surfaces of the planet wheels, and the sun wheel outer circumferential surfaces can taper toward the faces of the sun wheels that face each other.

Alternatively, the planet wheel outer circumferential surfaces can taper inwardly in the direction away from the end faces of the planet wheels, and the sun wheel outer circumferential surfaces can taper inwardly toward the faces of the sun wheels that face away from each other.

Advantageously, the planet wheel outer circumferential surfaces have a middle outer circumferential surface region for frictional contact with the inner circumferential surface of the ring wheel. The middle outer circumferential surfaces of the planet wheels are positioned between two outer circumferential surface regions that are each in frictional contact with a sun wheel outer circumferential surface, whereby the contact pressure force needed for the frictional contact acts uniformly on the planet wheels.

Because the middle outer circumferential contact surface region of the planet wheels is in the form of a circumferential groove, and the inner circumferential surface of the ring wheel is formed with a convex contour and is in frictional contact with each flank of the groove, tilting the planet wheels to change the transmission ratio between input and output drive is especially simplified.

Advantageously, when the planet wheels are in the tilted condition, a line through the two points of frictional contact of the inner circumferential surface of the ring wheel with the flanks of the groove, a line through the axes of rotation of the planet wheels, and a line through the axes of rotation of the sun wheels intersect at one point, whereby the axes of rotation of the planet wheels undergo a motion of precession when they are tilted.

The planetary gear train is stabilized by the fact that the planet wheels are held at substantially the same circumferential distance from each other by a separator element.

For changing the transmission ratio setting, the planetary transmission advantageously has a device for moving the ring wheel axially relative to the sun wheels.

Advantageously, the sun wheel outer circumferential surfaces, the planet wheel outer circumferential surfaces, and the inner circumferential surface of the ring wheel are so shaped that the distance between the sun wheels does not change, or increases only minimally, when the axes of rotation of the planet wheels are tilted relative to the axis of rotation of the sun wheels. That provides the contact pressure needed for a frictional transmission. With a slight increase in the sun wheel spacing, the planetary transmission has the tendency to return on its own to transmission ratio one, in which the axes of rotation of the planet wheels are parallel to each other.

Advantageously, the contours of the sun wheel outer circumferential surfaces, the planet wheel outer circumferential surfaces, and the inner circumferential surface of the ring wheel are so shaped that during transmission of torque from one sun wheel to the other, a tilting moment that reinforces the contact pressure between the surfaces that are in frictional contact acts on the planet wheels, which causes the contact pressure that is necessary for a frictional transmission to be produced, without adding components such as hydraulic pressure pistons.

Suitable materials, in addition to conventional steels, also include special steels, tool steels, or ceramic materials, as well as composite materials, from which at least individual ones of the components, or their outer surfaces or operating surfaces can be made. In general, all materials with increased hardness and/or wear resistance are advantageous.

Variations of the principle described herein that are also possible contain a kinematic exchange of the sun wheel and ring wheel functions, so that the transmission has two ring wheels that are separated from each other and only one sun wheel, while the rest of the structure and function remain comparable.

### BRIEF DESCRIPTION OF THE DRAWINGS

The structure, operation, and advantages of the present invention will become further apparent upon consideration of the following description, taken in conjunction with the accompanying drawings in which:

FIG. 1 is an end view of a planetary transmission in accordance with a first embodiment of the present invention;

FIG. 2 is a side sectional view of the planetary transmission shown in FIG. 1, taken along the line A-A thereof (not to scale);

FIG. 3 is an enlarged representation of a planet wheel of the planetary transmission shown in FIG. 1;

FIG. 4 is a fragmentary side view of two sun wheels, a ring wheel, and a planet wheel of the planetary transmission shown in FIG. 1, in which the planet wheel is tilted;

FIG. 5 is a schematic view of two sun wheels, a ring wheel, and a planet wheel of the planetary transmission shown in FIG. 1, in which the planet wheel is shown tilted relative to its upright position;

FIG. 6 is a fragmentary schematic end view of one sun wheel, part of a ring wheel, and a planet wheel of the planetary transmission shown in FIG. 1, in which the planet wheel is tilted;

FIG. 7 is a fragmentary schematic side view of another embodiment of the essential components of the planetary transmission, in which the planet wheel is tilted;

FIG. 8 is a fragmentary schematic side view of another embodiment of the essential components of the planetary transmission, in which the planet wheel is tilted; and

FIG. 9 is a fragmentary schematic side view of another embodiment of the essential components of the planetary transmission, in which the planet wheel is tilted.

### DESCRIPTION OF THE PREFERRED EMBODIMENTS

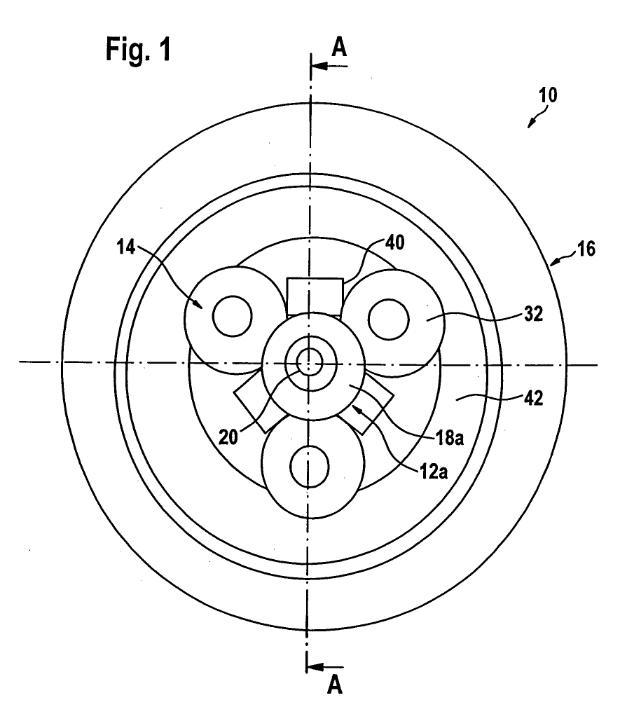

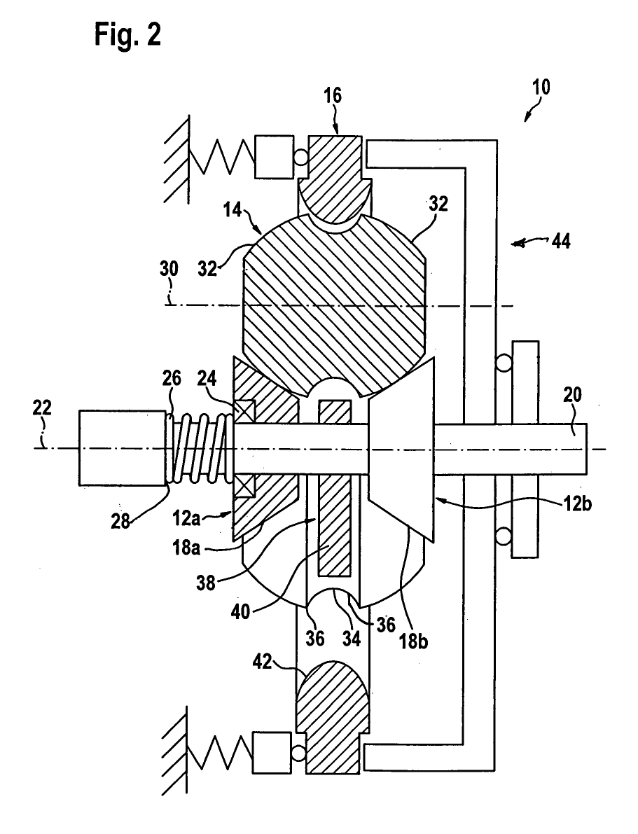

In FIGS. 1 and 2, a planetary transmission 10 with continuously variable transmission ratio includes two sun wheels 12a, 12b, three planet wheels 14, and one ring wheel 16. Sun wheels 12a, 12b taper downwardly and inwardly toward their facing ends, so that their sun wheel outer circumferential surfaces 18a, 18b are in the shape of a truncated circular cone. The contour line of sun wheel outer circumferential surfaces 18a, 18b is a straight line in the illustrated example. Sun wheels 12a, 12b are positioned at an axial distance from each other on a shaft 20 having an axis of rotation 22. One sun wheel 12a is axially movable along shaft 20 and is rotatable about shaft 20 by means of a bearing 24, for example a ball bearing. The other sun wheel 12b is rigidly attached to shaft 20. The side of planetary transmission 10 with the sun wheel 12a that is rotatable relative to shaft 20 is, for example, the input side. The side of planetary transmission 10 with sun wheel 12b that is rigidly attached to shaft 20 is the output side.

A spring 26 is supported between sun wheel 12a and a shoulder 28 of shaft 20, and biases sun wheel 12a in the axial direction toward sun wheel 12b.

Planet wheels 14 each have an axis of rotation 30 and taper starting from a central region toward their end faces, so that the planet wheel outer circumferential surfaces 32 are substantially in the shape of a truncated circular cone. In the illustrated example, the contour lines of the planet wheel outer circumferential surfaces 32 are convexly curved. Planet wheels 14 each include a circumferential groove 34 with rounded flanks 36 between the planet wheel outer circumferential surfaces 32. Planet wheels 14 are positioned coaxially on shaft 20, and each has one of its planet wheel outer circumferential surfaces 32 in frictional contact with one of the sun wheel outer circumferential surfaces 18a, 18b.

In addition, planetary transmission 10 has a star-shaped separator element 38 rotatably carried on shaft 20, and which is formed with projections 40 that extend into intermediate spaces between the planet wheels 14 and into the planet wheel circumferential grooves 34, so that the planet wheels 14 are held at the same circumferential distance from each other.

Ring wheel 16 advantageously has an annular ring shape, and is formed with a pointed-arch-shaped bulge having a convex cross section on its inner circumferential surface 42. Ring wheel 16 is positioned concentrically with shaft 20. Inner circumferential surface 42 is in frictional contact with each flank 36 of a groove 34 of a planet wheel.

The planet wheels 14 are axially retained by the frictional contact of the planet wheel outer circumferential surfaces 32 with the sun wheel outer circumferential surfaces 18a, 18b, and with the inner circumferential surface 42 of ring wheel 16. As shown in FIG. 4, when there is axial movement of ring wheel 16 relative to the axis of shaft 20, planet wheels 14 tilt, planet wheel outer circumferential surfaces 32, planet wheel groove 34, and inner circumferential surface 42 of ring wheel 16 are advantageously so shaped that in the tilted condition of planet wheels 14 the planet wheel axes of rotation 30, the axis of rotation 22 of shaft 20, and lines drawn through the two points of frictional contact of inner circumferential surface 42 of ring wheel 16 with the flanks 36 of groove 34 of planet wheel 14 intersect at a single point. The result is a well-defined motion of precession of planet wheels 14.

To move ring wheel 16 relative to shaft 20, a displacing device 44, which is shown only in FIG. 2, is in contact with ring wheel 16. In the illustrated example, displacing device 44 is formed similarly to a clutch actuator, and it is therefore not explained in greater detail.

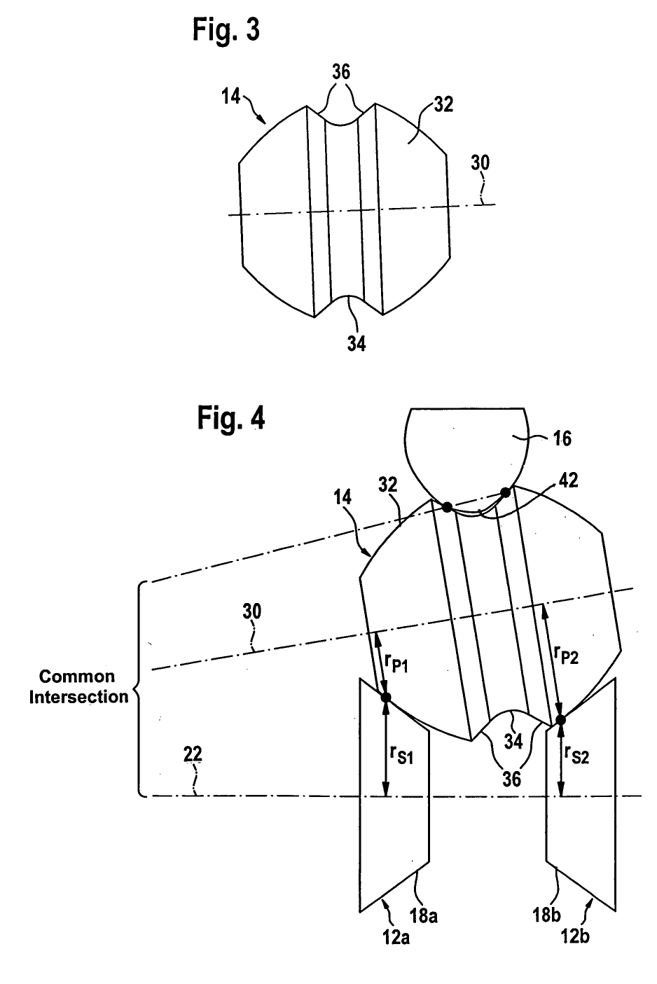

For further clarification, FIG. 3 is a side view of a planet wheel 14 as used in the planetary transmission shown in FIGS. 1 and 2 in an enlarged representation, and more clearly showing flanks 36 of circumferential groove 34 of planet wheel 14.

The operating principle of the planetary transmission will be explained below on the basis of FIGS. 1-6.

The description of the operating principle of planetary transmission 10 is based upon the following definitions:

r_{S1} is the distance between axis of rotation 22 of shaft 20 and the point of frictional contact of sun wheel outer circumferential surface 18a with planet wheel outer circumferential surface 32;

r_{S2} is the distance between axis of rotation 22 of shaft 20 and the point of frictional contact of sun wheel outer circumferential surface 18b with planet wheel outer circumferential surface 32;

r_{P1} is the distance between axis of rotation 30 of planet wheel 14 and the point of frictional contact of planet wheel outer circumferential surface 32 with sun wheel outer circumferential surface 18a;

r_{P2} is the distance between axis of rotation 30 of planet wheel 14 and the point of frictional contact of planet wheel outer circumferential surface 32 with sun wheel outer circumferential surface 18b;

n_{S1} is the speed of rotation of sun wheel 12a;

n_{S2} is the speed of rotation of sun wheel 12b;

n_{P} is the speed of rotation of planet wheels 14; and

ΔS is the axial distance of sun wheels 12a, 12b from each other.

In general, the following equation applies to the transmission of torque by planetary transmission 10:
n_{S1}×r_{S1}=n_{P}×r_{P1} and n_{S2}×r_{S2}=n_{P}×r_{P2}

The description of the operating principle begins with the planet wheels 14 in a non-tilted condition. In that condition, with a symmetrical arrangement of the planetary transmission 10, the following equalities are true:
r_{S1}=r_{S2}; r_{P1}=r_{P2}, and therefore n_{S1}=n_{S2}.

The transmission ratio i between drive and take-off is then i=1.

When ring wheel 16 is moved axially relative to sun wheels 12a, 12b, planet wheels 14 are carried along with it by virtue of contact with the flanks 36 of the grooves 34, and consequently the axes of rotation 30 of the planet wheels 14 are tilted relative to the axis of rotation 22 of the sun wheels 12a, 12b. If axis of rotation 30 is tilted toward sun wheel 12a, as shown in FIG. 4, then r_{S1}>r_{S2} and r_{P1}<r_{P2}, i.e., n_{S1<n}_{S2}. If axis of rotation 30 is tilted toward sun wheel 12b, the relationships just stated above are accordingly reversed. The transmission ratio between n_{S1} and n_{S2} thus changes in accordance with the magnitude and direction of the axial movement of displacing device 44 along axis 22. At the same time, the transmission ratios between ring wheel 16 and each of the sun wheels 12a, 12b change in the opposite direction.

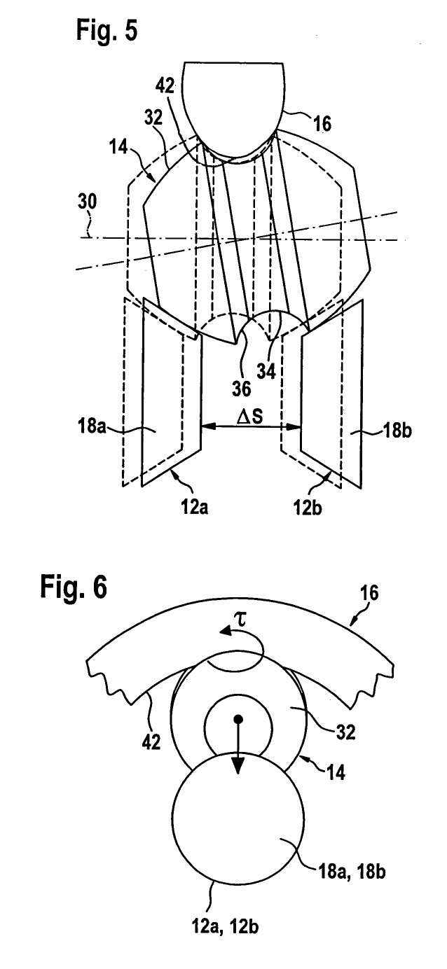

The outer conical surfaces 18a, 18b of sun wheels 12a, 12b can be formed so that the distance ΔS (see FIG. 5) between the opposed end faces of the sun wheels 12a, 12b remains constant when the axes of rotation 30 of the planet wheels 14 are tilted, i.e., when the transmission ratio is shifted. Contact pressure between the sun wheels 12a, 12b, the planet wheels 14, and the ring wheel 16 is maintained by the spring 26.

Advantageously, the outer conical surfaces 18a, 18b of sun wheels 12a, 12b are formed so that the distance ΔS increases somewhat when the axes of rotation 30 of the planet wheels are tilted from their parallelism with the axis of rotation 22 of shaft 20. The result is that the transmission 10 returns on its own to its neutral position (i=1), and that maximum contact pressure forces are present at maximum high and maximum low transmission ratios.

When torque is transmitted between input and output, because of the frictional contacts of the planet wheels 14 with the sun wheels 12 and with ring wheel 16, a tilting moment τ is produced, as can be seen in FIG. 6, which tilting moment pivots the planet wheels 14 around an axis perpendicular to their respective axes of rotation 30. The contours of the sun wheel outer circumferential surfaces 18a, 18b, of the planet wheel outer contour surface 32, and of the inner circumferential surface 42 are so shaped that the tilting moment τ also presses the planet wheels 14 radially inwardly and reinforces the contact pressure between sun wheel outer circumferential surfaces 18a, 18b, planet wheel outer circumferential surfaces 32, and inner circumferential surface 42 of ring wheel 16. The result is that the contact pressure increases as the torque transmitted by the planetary transmission 10 increases; that is, planetary transmission 10 is in a certain sense self-clamping. Spring 26 could be dispensed with in that case, if sun wheels 12a, 12b are axially held relative to each other.

The planetary transmission in accordance with the present invention can be modified in many ways:

The sun wheels can differ in size. The contours of the outer circumferential surfaces can be concave, convex, or rectilinear, in coordination with each other.

The inner circumferential surface of the ring wheel can be in frictional contact with the planet wheel outer circumferential surfaces at only one point.

A planetary carrier whose supports are penetrated by the planet wheels can be positioned so that another gear can be engaged with it.

Spring 26 can be replaced by other biasing means.

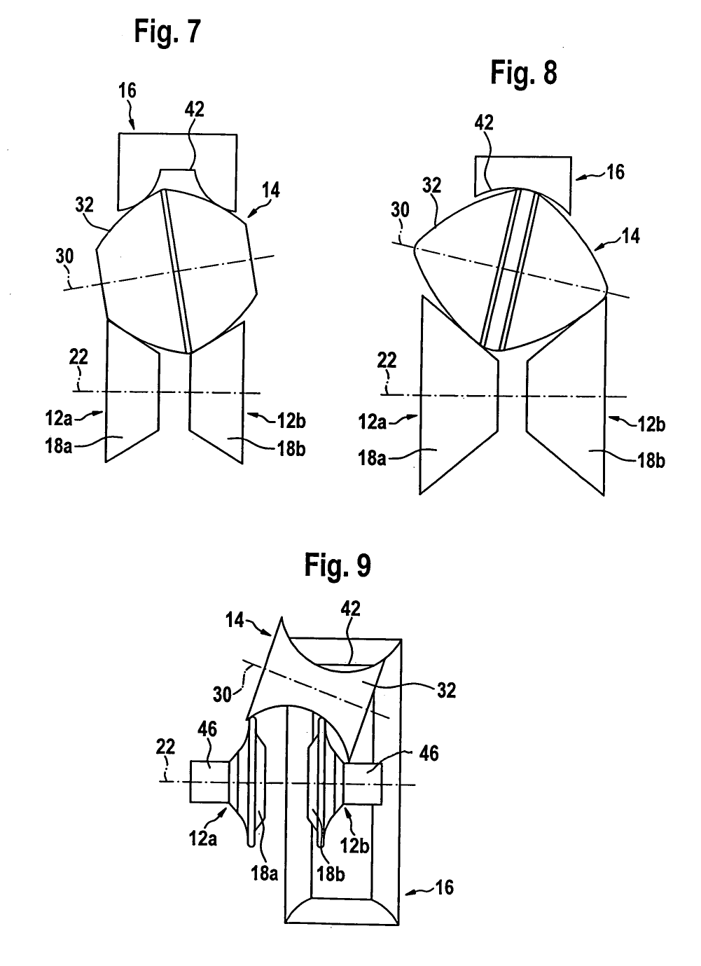

Other possible embodiments of the planetary transmission are illustrated in FIGS. 7 through 9.

FIG. 7 shows an embodiment in which the sun wheels 12a, 12b are formed and positioned similarly to those shown in FIGS. 1-4. The planet wheels 14 have a similar shape to that of the planet wheels 14 in FIGS. 1-4, but are formed without a groove. Ring wheel 16 has on its inner circumferential surface 42 two convex inner circumferential surfaces, which as a whole form the flanks of an inner circumferential surface that define a groove, each of which flanks is in frictional contact with one of the planet wheel outer circumferential surfaces 32.

FIG. 8 shows an additional embodiment in which the sun wheels 12a, 12b are formed and positioned similarly to those shown in FIGS. 1 through 4. The planet wheels 14 taper toward their axial ends, so that the planet wheel outer circumferential surfaces 32 are essentially in the shape of circular cones and have convexly curved contours. The planet wheel outer circumferential surfaces 32 have a smaller radius of curvature in a middle region than at the end regions. Ring wheel 16 has on its inner circumferential surface 42 a substantially concave cross section, whose radius of curvature is advantageously somewhat larger than the radius of curvature of the middle region of the planet wheel outer circumferential surfaces 32, so that the inner circumferential surface 42 of ring wheel 16 contacts the middle region of the planet wheel outer circumferential surfaces 32 at one point.

Alternatively, the planet wheel outer circumferential surfaces 32 can have two parallel, circumferential bulges in the vicinity of the middle region, so that the inner circumferential surface 42 of ring wheel 16 contacts the planet wheel outer circumferential surfaces 32 at two points.

FIG. 9 shows a further embodiment of the present invention, in which axially narrow sun wheel outer circumferential surfaces 18a, 18b are in the form of truncated circular cones and have concavely curved contours. Sun wheels 12a, 12b are positioned on their own respective shafts 46, which are coaxial, and in such a way that their tapered end faces of sun wheels 12a, 12b are opposite each other. Planet wheel outer circumferential surfaces 32 are formed without an intermediate groove or bulge, and have a concave contour. The inner circumferential surface 42 of ring wheel 16 is defined by two axially spaced convex end regions, which are connected by a rectilinear region that is parallel to the axis of rotation 22. Each convex end region of the inner circumferential surface 42 is in frictional contact with the concave outer circumferential surfaces of the planet wheels 14.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A planetary transmission having a continuously variable transmission ratio, said transmission comprising:
first and second sun wheels each having a sun wheel outer circumferential surface, which surfaces are rotatable at different relative speeds around a common sun wheel axis of rotation, wherein the sun wheels are spaced at an axial distance from each other;
an annular ring wheel having a radially inner circumferential surface, wherein the ring wheel is radially outwardly of and positioned coaxially with the sun wheels;
planet wheels positioned between the sun wheels and the ring wheel and having respective planet wheel axes of rotation, the planet wheels including planet wheel outer circumferential surfaces that are in frictional contact with the inner circumferential surface of the ring wheel and with the outer circumferential surfaces of each of the sun wheels; and
wherein the sun wheel outer circumferential surfaces, the planet wheel outer circumferential surfaces, and the inner circumferential surface of the ring wheel are so shaped that upon axial movement of the ring wheel relative to the sun wheels, the axes of rotation of the planet wheels tilt relative to the axis of rotation of the sun wheels, whereby rotational speeds of the sun wheels change as a function of the magnitude and direction of axial movement of the ring wheel to vary the transmission ratio of the transmission.

2. A planetary transmission in accordance with claim 1, wherein each planet wheel outer circumferential surface is in frictional contact with each of the sun wheels on different sides of an intermediate plane that is positioned between the sun wheels and that extends perpendicularly to the axis of rotation of the sun wheels, and wherein each planet wheel outer circumferential surface is in frictional contact with the inner circumferential surface of the ring wheel at at least one position, and the planet wheel outer circumferential surfaces are so shaped that the planet wheels are retained axially by the frictional contact with each of the sun wheels and the ring wheel.

3. A planetary transmission in accordance with claim 1, wherein the first sun wheel is rigidly attached to a shaft and the second sun wheel is rotatably carried on the shaft and is biased in a direction toward the first sun wheel.

4. A planetary transmission in accordance with claim 1, wherein the outer circumferential surfaces of the planet wheels taper toward axially spaced ends of the respective planet wheels, and the sun wheel outer circumferential surfaces taper radially inwardly toward end faces of the sun wheels that face each other.

5. A planetary transmission in accordance with claim 1, wherein the outer circumferential surfaces of the planet wheels taper inwardly in a direction away from end faces of the planet wheels, and the sun wheel outer circumferential surfaces taper inwardly toward end faces of the sun wheels that face away from each other.

6. A planetary transmission in accordance with claim 1, wherein the outer circumferential surfaces of the planet wheels include a middle circumferential surface region for frictional contact with the inner circumferential surface of the ring wheel, and wherein the middle circumferential surface region is positioned between two circumferential surface regions that frictionally contact a respective sun wheel outer circumferential surface.

7. A planetary transmission in accordance with claim 6, wherein the middle circumferential surface region is a circumferential groove.

8. A planetary transmission in accordance with claim 7, wherein the inner circumferential surface of the ring wheel includes a convex contour that is in frictional contact with each side of the grooves of the planet wheels.

9. A planetary transmission in accordance with claim 8, wherein a line extending through the two points of frictional contact of the inner circumferential surface of the ring wheel with the sides of the grooves of the planet wheels intersects extensions of the axes of rotation of the planet wheels and an extension of the axis of rotation of the sun wheels at a common point when the axes of rotation of the planet wheels are in a tilted condition relative to the axis of rotation of the sun wheels.

10. A planetary transmission in accordance with claim 1, wherein respective planet wheels are retained at substantially the same circumferential spacing from each other by a separator element.

11. A planetary transmission in accordance with claim 1, including means for moving the ring wheel axially relative to the axis of rotation of the sun wheels.

12. A planetary transmission in accordance with claim 1, wherein the sun wheel outer circumferential surfaces, the planet wheel outer circumferential surfaces, and the inner circumferential surface of the ring wheel are so shaped that the spacing between the sun wheels increases when the axes of rotation of the planet wheels are tilted relative to the axis of rotation of the sun wheels.

13. A planetary transmission in accordance with claim 1, wherein surface contours of the sun wheel outer circumferential surfaces, surface contours of the planet wheel outer circumferential surfaces, and the inner circumferential surface of the ring wheel are so shaped that when torque is transmitted from one sun wheel to the other a tilting moment acts on the planet wheels that reinforces contact pressure between the surfaces that are in frictional contact.
